(19) United States
(12) Patent Application Publication
(10) Pub. No.: US 2026/0230978 A1
(43) Pub. Date: Aug. 6, 2026

(54) METHOD, USER EQUIPMENT AND NETWORK NODE FOR SIDELINK BASED ENERGY EFFICIENT COMMUNICATION

(71) Applicant: Continental Automotive Technologies GmbH, Hannover (DE)

(72) Inventors: Shravan Kumar KALYANKAR, Singapore (SG); David GONZALEZ GONZALEZ, Egelsbach, Hessen (DE); Reuben GEORGE STEPHEN, Singapore (SG); Rikin SHAH, Langen, Hessen (DE)

(73) Assignee: Continental Automotive Technologies GmbH, Hannover (DE)

(21) Appl. No.: 19/154,916

(22) PCT Filed: Jan. 29, 2024
(86) PCT No.: PCT/EP2024/052021

§ 371 Date: Aug. 8, 2025

(30) Foreign Application Priority Data
Feb. 10, 2023 (DE) 10 2023 201 134.4

(51) Int. Cl. H04W 36/14; H04B 17/318; H04W 8/00; H04W 76/20; H04W 92/18

(52) U.S. Cl. CPC H04W 36/144; H04B 17/328; H04W 8/005; H04W 76/20; H04W 92/18

(57) ABSTRACT

A method for sidelink based energy efficient communication performed by a remote user equipment, UE. According to the method, it is determined whether a random access, RA, procedure failure in a communication with a network node has reached a predetermined threshold. In response to determining that the RA procedure failure has reached the predetermined threshold, the remote UE decides whether to upgrade to a higher coverage enhancement, CE, level in the communication with the network node; or switch to a sidelink communication via a relay UE. Also disclosed is a corresponding remote UE and a corresponding network node.

### CROSS REFERENCE TO RELATED APPLICATIONS

This application is the U.S. National Phase Application of PCT International Application No. PCT/EP2024/052021, filed Jan. 29, 2024, which claims priority to German Patent Application No. 10 2023 201 134.4, filed Feb. 10, 2023, the contents of such applications being incorporated by reference herein.

### TECHNICAL FIELD

The invention relates to a method for sidelink based energy efficient communication. The invention further relates to a corresponding remote user equipment and a corresponding network node.

### BACKGROUND

Remote user equipment that is operated in poor coverage conditions will be operated at higher coverage enhancement levels in order to compensate for the poor coverage. This, however, leads to an increased energy consumption. Due to the increased energy consumption, the battery life of the user equipment will be shortened.

### SUMMARY

An aspect of the invention is a method for communication that is more energy efficient. A further aspect of the present invention is a corresponding user equipment and a corresponding network node.

According to an aspect of the invention, a method for sidelink based energy efficient communication performed by a remote user equipment (UE) is provided.

In this context, “sidelink”, while being a 3GPP terminology, refers to device-to-device communication, i.e., UE-to-UE communication in general. That is, the sidelink communication refers to a special kind of communication mechanism between device and device without going through a network node.

As will be seen later, the method is energy efficient. In this context, energy efficient means that the remote user equipment is operated efficiently, i.e., with a lower energy consumption.

The communication may be a multi-hop communication, i.e., a communication that uses several nodes as relays between the UE and the destination node.

The remote UE may be any remote UE that is either mobile or fixedly installed. In particular, the remote UE may be battery powered. The remote UE may be, e.g., a mobile device such as a mobile phone, an internet of things (IoT) device and/or a massive IoT device. In particular for massive IoT devices, an energy efficient operation is extremely valuable to extend the battery life.

According to the method, the remote UE performs communication with a network node and determines whether a random access (RA) procedure failure in said communication with the network node has reached a predetermined threshold.

The network node may be, e.g., an evolved node B (eNodeB, eNB) or a next generation node B (gNodeB, gNB).

The RA procedure is a process initiated by the remote UE to request uplink radio resources that are required to send data. This request has to be replied to by the network node. If, however, such a reply is not received by the remote UE, the RA procedure has failed.

The predetermined threshold is set for the remote UE. It is possible that this predetermined threshold is changed, e.g., based on remaining battery life of the remote UE.

When the RA procedure failure, i.e., the number of unsuccessful RA procedures, has reached the predetermined threshold, the remote UE decides whether to upgrade to a higher coverage enhancement (CE) level in the communication with the network node or to switch to a sidelink communication via a relay UE.

In this context, a higher CE level may mean an increased retransmission, i.e., an increased repetition of RA requests in case of no RA response, an increased repetition, i.e., an increased repetition of preambles to improve the probability of detection at the network node, and/or a power ramping, i.e., an increased transmit power level that shall compensate for a higher path loss, for in-band and/or guard band operating modes. The higher CE level may lead to an increased communication quality but has also a higher energy consumption compared to a lower CE level due to the increased repetitions and/or increased communication power.

The other option is to switch to a sidelink communication via a relay UE. In this case, the relay UE will relay the communication from the remote UE to the network node and back. Further, the CE level will not be increased when the communication is switched to the sidelink communication via the relay UE. Hence, compared to upgrading to a higher CE level, energy is saved.

Therefore, by offering the option to switch to a sidelink communication instead of only upgrading to a higher CE level, energy is saved and the provided method is more energy efficient.

According to an embodiment, the sidelink communication is within a 3GPP network, i.e., it is a “real” sidelink communication. In particular, the 3GPP network may be a 5G and/or a 6G network. While the method work particularly well for 3GPP networks, it can also be applied to other networks that offer device-to-device communication.

According to an embodiment, the remote UE receives system information. Said system information is periodically broadcast by the network node and comprises relay UE information. In particular, the system information may comprise information on available relay UEs that may be used by the remote UE to decide whether to upgrade to the higher CE level or to switch to a sidelink communication.

According to an embodiment, the system information includes directives on whether to upgrade to a higher CE level or to switch to a sidelink communication. Hence, when the RA procedure failure has reached the predetermined threshold, the remote UE makes the decision whether to upgrade to the higher CE level or to switch to the sidelink communication according to the directives in the system information. Hence, the network node may control whether UEs shall upgrade to a higher CE level or to switch to a sidelink communication. This decision may be made by the network node, e.g., based on traffic in the sidelink frequency bands: if there is already a lot of traffic in the sidelink frequency bands, the network node may send directives to not switch to the sidelink communication such that the sidelink frequency bands do not receive even more traffic.

According to an embodiment, the remote UE determines whether a radio resource control (RRC) reconfiguration message has been received. The step of deciding is then based on whether the RRC reconfiguration message has been received. Here, the RRC reconfiguration message may comprise a reconfiguration to a sidelink communication via a relay UE. If the RRC reconfiguration message has been received, the remote UE will switch to the sidelink communication when the RA procedure failure has reached the predetermined threshold. If, on the other hand, the RRC reconfiguration message has not been received, the remote UE will upgrade to the higher CE level when the RA procedure failure has reached the predetermined threshold. It is to be noted that, while the decision on whether to switch to the sidelink communication or not is made by the network node, the actual switching to the sidelink communication is triggered by the remote UE, when it is determined that the RA procedure failure has reached the predetermined threshold.

According to an embodiment, the remote UE receives relay operation information. Said relay operation information is broadcast by at least one relay UE and comprises important information relating to the relay UE and the communication via the relay UE, in particular, a CE level of the relay UE, an indication of a reference signal for reference signal received power (RSRP) measurement and/or a relay UE energy status. Here, the indication of the reference signal allows the remote UE to use the correct reference signal for a RSRP measurement. The UE energy status provides information on the status of the UE's energy supply, e.g., whether the UE has sufficient energy or whether the UE has an energy deficit.

According to an embodiment, the relay operation information is broadcast periodically by the at least one relay UE. That way, the remote UE may periodically update the relay operation information of the relay UE.

Alternatively, or additionally, the remote UE has to request the relay operation information prior to receiving the relay operation information. That is, the relay UE provides the relay operation information upon request.

According to an embodiment, the remote UE discovers, based on the received relay operation information, a best relay UE. “Best” may in this case be based on energy and/or connection considerations. For example, a relay UE with a lower CE level is considered better than a relay UE with a higher CE level. As another example, a relay UE with a higher RSRP is considered better than a relay UE with a lower RSRP. Then, the decision whether to upgrade to the higher CE level or to switch to the sidelink communication is based on the received relay operation of the best relay UE, i.e., of the relay UE that has been discovered the best relay UE. Said decision may be based on the CE level of the relay UE: if the relay UE already has a high CE level, switching to the sidelink communication would not lead to energy savings. Also, if the RSRP is low, the connection between the remote UE and the relay UE seems to be subpar such that switching to the sidelink communication would lead to weak connection.

According to an embodiment, the remote UE broadcasts a relay UE request to at least one relay UE. Said relay UE request may request relay UEs that are suitable for an energy efficient operation of the remote UE. The relay UE request may comprise a required CE level of the relay UE, an indication of a reference signal for RSRP measurement, a minimum required reference signal received power and/or a required relay UE energy status. If the relay UE has a CE level higher than the required CE level, it is not suitable for an energy efficient sidelink communication. If the RSRP is lower than the minimum required RSRP, the sidelink communication would be too weak. And if the battery of the relay UE is too weak, i.e., the relay UE energy status is energy deficient, a sidelink communication with said relay UE would not last very long and would strain the battery of the relay UE even faster. If the relay UE meets the requirements of the relay UE request, it sends a relay UE response to the remote UE. The remote UE then receives the relay UE response and makes the decision whether to upgrade to the higher CE level or to switch to the sidelink communication based on the at least one received UE response. In particular, the relay UE request may be such that when a relay UE responds to the relay UE request, the relay UE fulfills the conditions for switching to the sidelink communication. Hence, if the remote UE receives at least one relay UE response, it may decide to switch to the sidelink communication. If, however, the remote UE receives no relay UE response, there is no relay UE around that fulfills the conditions for switching to the sidelink communication and hence, the remote UE will upgrade to a higher CE level.

According to another aspect of the invention, a remote user equipment (UE) is provided. The remote UE is configured to perform the method according to the above description. Hence, the advantages and further embodiments correspond to those given in the above description. In particular, the remote UE may be operated in an energy efficient manner.

According to yet another aspect of the invention, a network node is provided. The network node is configured to periodically broadcast system information. Said system information comprises relay user equipment (UE) information.

According to an embodiment, the system information includes directives for a remote UE on whether to upgrade to a higher coverage enhancement (CE) level or to switch to a sidelink communication. This decision is based on the CE levels of the relay UEs, the CE levels of the remote UEs, network traffic and relay UE energy status. If the CE level of the relay UE is high, switching to the sidelink communication does not lead to energy savings, hence, the network node would issue a directive to upgrade to a higher CE level. If, on the other hand, the CE level of the remote UE is already high, switching to a sidelink communication results in even higher energy savings. Further, if there is already a lot of network traffic in the sidelink frequency bands, the network node sends directives to not switch to the sidelink communication such that the sidelink frequency bands do not receive even more traffic. Also, if the relay UE energy status indicates an energy deficit of the relay UE, the network node sends directives to not switch to the sidelink communication such that the relay UE does not have an even higher energy consumption due to the sidelink communication with the remote UE. Further advantages and embodiments correspond to those given in the above description.

As yet another aspect of the invention, another network node is provided. Said network node is configured to assess a network communication with a remote user equipment (UE). Then, the network node is configured to determine whether to switch the network communication to the sidelink communication. This determination is based on CE levels of relay UEs, CE levels of remote UEs, the network traffic and/or a relay UE energy status. If the CE level of the relay UE is high, switching to the sidelink communication does not lead to energy savings, hence, the network node does not initiate switching to the sidelink communication. If, on the other hand, the CE level of the remote UE is already high, switching to a sidelink communication results in even higher energy savings. Further, if there is already a lot of network traffic in the sidelink frequency bands, the network node does not initiate the switch to the sidelink communication such that the sidelink frequency bands do not receive even more traffic. Also, if the relay UE energy status indicates an energy deficit of the relay UE, the network node does not initiate the switch to the sidelink communication such that the relay UE does not have an even higher energy consumption due to the sidelink communication with the remote UE. If it is determined that the remote UE shall switch the network communication to the sidelink communication, the network node performs a radio resource control (RRC) reconfiguration for the relay UE, i.e., it sets up the relay UE for a sidelink communication. Further, the network node performs an RRC reconfiguration for the remote UE, i.e., it sets up the remote UE for a sidelink communication. The actual switch to the sidelink communication is then triggered by the remote UE. Further advantages and embodiments correspond to those given in the above description.

### BRIEF DESCRIPTION OF THE DRAWINGS

These and other aspects of the invention will be apparent from and elucidated further with reference to the embodiments described by way of examples in the following description and with reference to the accompanying drawings, in which

FIG. 1 schematically shows a communications setup;

FIG. 2 shows a flowchart of an embodiment of a method for energy efficient communication;

FIG. 3 shows a flowchart of another embodiment of a method for energy efficient communication;

FIG. 4 shows a flowchart of yet another embodiment of a method for energy efficient communication;

FIG. 5 shows a flowchart of yet another embodiment of a method for energy efficient communication.

In the figures, elements which correspond to elements already described may have the same reference numerals. Examples, embodiments or optional features, whether indicated as non-limiting or not, are not to be understood as limiting aspects of the invention as claimed.

### DESCRIPTION OF EMBODIMENTS

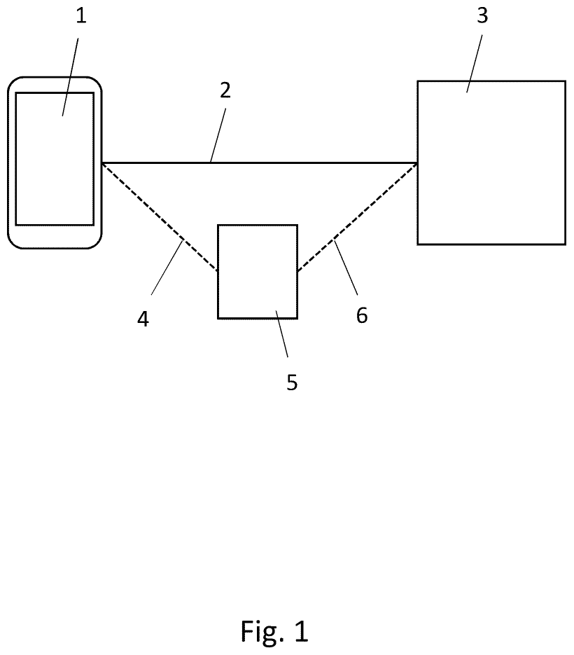

FIG. 1 schematically shows a communications setup where a remote user equipment (UE) 1 has established a direct communication 2 with a network node 3. Here, the remote UE 1 may be any remote UE that is either mobile or fixedly installed. In particular, the remote UE 1 may be battery powered. The remote UE 1 may be, e.g., a mobile device such as a mobile phone, an internet of things (IoT) device and/or a massive IoT device. Further, the network node 3 may be, e.g., an evolved node B (eNodeB, eNB) or a next generation node B (gNodeB, gNB).

As an alternative to the direct communication 2 with the network node 3, FIG. 1 shows a sidelink communication 4 (shown as dashed lines) of the remote UE 1 with a relay UE 5. The relay UE 5 then communicates with the network node 3 via another direct communication 6.

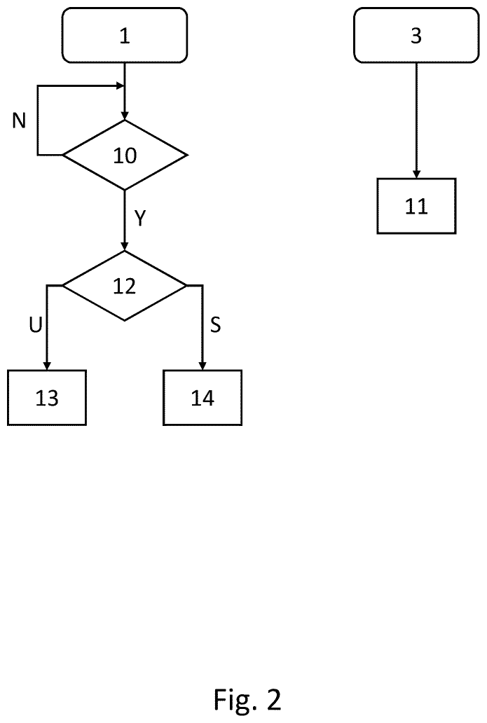

FIG. 2 shows a flowchart of an embodiment of a method for energy efficient communication. According to the method, the remote UE 1 periodically performs random access (RA) procedures and determines 10 whether a predetermined maximum RA procedure failure has been reached. This predetermined maximum RA procedure failure may depend on a current coverage enhancement (CE) level of the remote UE 1.

While the remote UE 1 performs the RA procedures, the network node 3 periodically broadcasts 11 system information that comprises relay UE information and, in particular, includes directives on whether to upgrade to a higher CE level or to switch to a sidelink communication 4.

The remote UE 1 receives the system information from the network node 3. In response to determining 10 that the RA procedure failure has reached the maximum RA procedure failure Y, a decision 12 is made whether to upgrade U to a higher CE level 13 or to switch S to a sidelink communication 14. If it is determined that the communication is switched to the sidelink communication 14, energy may be saved compared to upgrading to a higher CE level 13, hence, the method is energy efficient.

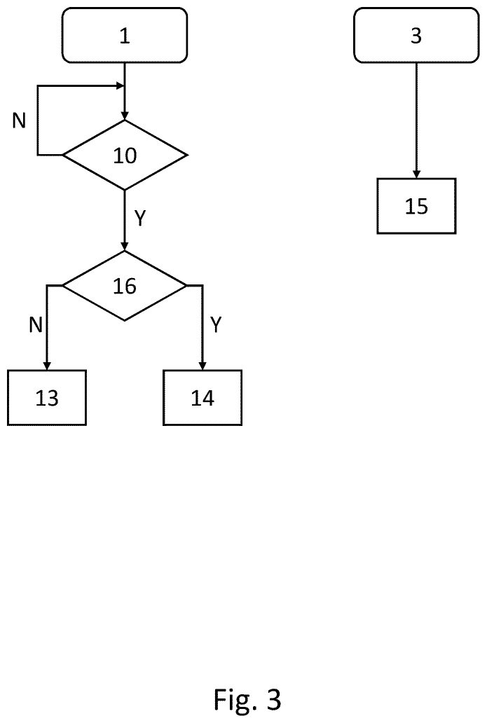

FIG. 3 shows a flowchart of another embodiment of a method for energy efficient communication. Here, the network node 3 assesses the direct communication 2 with the remote UE 1 and decides 15 whether the remote UE 1 is to upgrade to a higher CE level or whether the remote UE 1 is to switch to a sidelink communication 4. If the network node 3 decides that the remote UE 1 is to switch to a sidelink communication 4, it sets up the sidelink communication 4: the network node 3 performs a radio resource control (RRC) reconfiguration of the relay UE 5 and then sends an RRC reconfiguration message to the remote UE 1.

In response to determining that the RA procedure failure has reached the maximum RA procedure failure Y, the remote UE 1 checks whether an RRC reconfiguration message has been received 16. If no RRC reconfiguration message has been received N, the remote UE 1 upgrades to a higher CE level 13. If, on the other, an RRC reconfiguration message has been received Y, the remote UE 1 completes the switch to the sidelink communication 14, in particular by establishing the sidelink communication 2 and sending an RRC reconfiguration complete message to the network node 3.

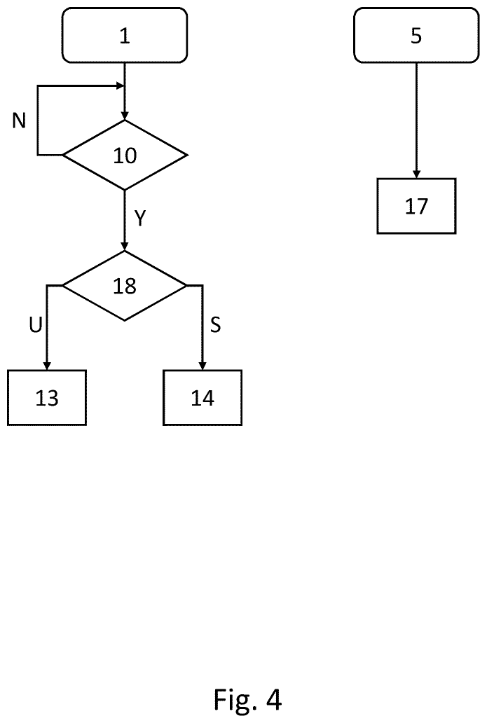

FIG. 4 shows a flowchart of yet another embodiment of a method for energy efficient communication. Here, the relay UEs 5 broadcast relay operation information 17. The relay operation information comprises a CE level of the relay UE 5, an indication of a reference signal for reference signal received power (RSRP) measurement, and/or a relay UE energy status.

The remote UE 1 receives the relay operation information, discovers, based on the received relay operation information, a best relay UE 5 and decides 18 whether to upgrade U to a higher CE level 13 or to switch S to a sidelink communication 14, based on the received relay operation information.

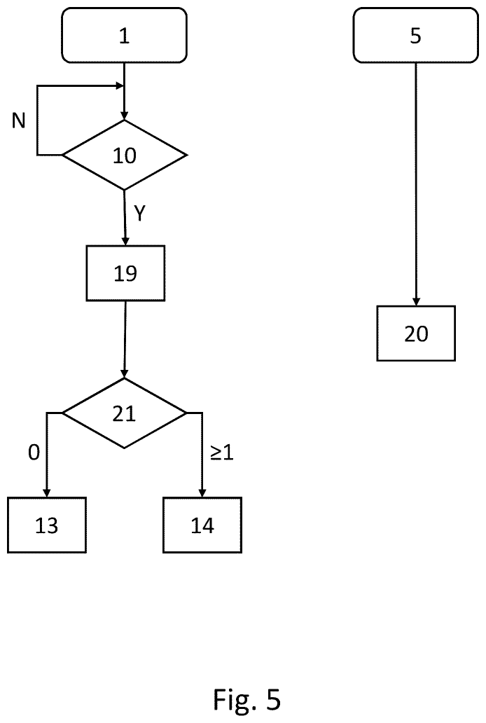

FIG. 5 shows a flowchart of yet another embodiment of a method for energy efficient communication. Here, the remote UE 1 broadcasts a relay UE request 19. Said relay UE request comprises a required CE level of the relay UE 5, and indication of a reference signal for RSRP measurement, a minimum required RSRP, and a required relay UE energy status. If a relay UE 5 fulfills the conditions of the relay UE request, it sends a corresponding relay response 20.

The remote UE 1 receives responses by relay UEs to the relay UE request 21. If no response is received 0, no suitable relay UE 5 has been found and the remote UE proceeds with upgrading to a higher CE level 13. If, on the other hand, at least one suitable relay UE 5 has been found ≥1, the network communication will be switched to a sidelink communication 14.

In all of the above embodiments, if it is determined that the communication is switched to the sidelink communication 14, energy may be saved compared to upgrading to a higher CE level 13, hence, the method is energy efficient.

Other variations to the disclosed embodiments can be understood and effected by those skilled in the art in practicing the claimed invention, from the study of the drawings, the disclosure, and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

### LIST OF REFERENCE SIGNS

1 remote UE
2 direct communication
3 network node
4 sidelink communication
5 relay UE
6 other direct communication
11 broadcast system information
12 decision
13 upgrade to higher CE level
14 switch to sidelink communication
15 decision
16 checking
17 broadcast relay operation information
18 decision
19 broadcast relay UE request
20 sending a relay response
21 receiving responses

1. A method for sidelink based energy efficient communication performed by a remote user equipment (1), UE, the method comprising:
determining whether a random access, RA, procedure failure in a communication with a network node has reached a predetermined threshold; and
in response to determining that the RA procedure failure has reached the predetermined threshold:
deciding whether to
upgrade to a higher coverage enhancement, CE, level in the communication with the network node; or
switch to a sidelink communication via a relay UE.

2. The method according to claim 1, wherein the sidelink communication is within a 3GPP network, in particular a 5G and/or a 6G network.

3. The method according to claim 1, further comprising: receiving system information, wherein the system information is periodically broadcast by the network node and comprises relay UE information.

4. The method according to claim 3, wherein the system information includes directives on whether to upgrade to a higher CE level or to switch to a sidelink communication and the step of deciding is based on the directives of the system information.

5. The method according to claim 1, further comprising:
determining whether a radio resource control, RRC, reconfiguration message has been received,
wherein the step of deciding is based on whether the RRC reconfiguration message has been received.

6. The method according to claim 1, further comprising: receiving relay operation information, wherein the relay operation information is broadcast by at least one relay UE and comprises at least one out of the following:
CE level of the relay UE;
indication of a reference signal for reference signal received power, RSRP, measurement; and
relay UE energy status.

7. The method according to claim 6, wherein the relay operation information is broadcast periodically by the at least one relay UE and/or the method further comprises, prior to receiving relay operation information:
requesting relay operation information.

8. The method according to claim 6, further comprising:
discovering, based on the received relay operation information, a best relay UE, wherein
the step of deciding is based on the received relay operation information of the best relay UE.

9. The method according to claim 1, further comprising:
broadcasting a relay UE request to at least one relay UE, wherein the relay UE request comprises at least one out of the following:
a required CE level of the relay UE;
indication of a reference signal for reference signal received power, RSRP, measurement;
a minimum required reference signal received power; and
a required relay UE energy status; and
receiving at least one relay UE response from the at least one relay UE, wherein the step of deciding is based on the at least one received UE response.

10. A remote user equipment UE, configured to perform the method according to claim 1.

11. A network node, configured to periodically broadcast system information, wherein the system information comprises relay user equipment, UE, information.

12. The network node according to claim 11, wherein the system information includes directives for remote user equipment, UEs, whether to upgrade to a higher coverage enhancement, CE, level or to switch to a sidelink communication, and the directives are based on at least one out of the following:
CE levels of relay UEs;
CE levels of remote UEs;
network traffic; and
relay UE energy status.

13. A network node, configured to:
assess a network communication with a remote user equipment, UE;
determine whether to switch the network communication to a sidelink communication, based on at least one out of the following:
CE levels of relay UEs;
CE levels of remote UEs;
network traffic; and
relay UE energy status; and
in response to determining to switch the network communication to a sidelink communication:
performing a radio resource control, RRC, reconfiguration for the relay UE; and
performing an RRC reconfiguration for the remote UE.
